(19) United States
(12) Patent Application Publication
(10) Pub. No.: US 2025/0315919 A1
(43) Pub. Date: Oct. 9, 2025

(54) Fourier Ptychographic Generation of an Image

(71) Applicant: Siemens Aktiengesellschaft, München (DE)

(72) Inventor: Thomas Engel, Aalen (DE)

(73) Assignee: Siemens Aktiengesellschaft, München (DE)

(21) Appl. No.: 18/864,749

(22) PCT Filed: May 10, 2023
(86) PCT No.: PCT/EP2023/062346

§ 371 Date: Nov. 11, 2024

(30) Foreign Application Priority Data
May 12, 2022 (EP) 22172989.0

(51) Int. Cl. G06T 5/10; G02B 21/08; G02B 21/36; G06T 5/50

(52) U.S. Cl. CPC G06T 5/10; G02B 21/08; G02B 21/365; G06T 5/50; G06T 2207/10024; G06T 2207/10056

(57) ABSTRACT

Various embodiments of the teachings herein include a method for the Fourier ptychographic generation of an image of an object by means of a color-corrected optical unit. An example includes: illuminating the object with a multiplicity of illumination elements arranged in distributed fashion at a corresponding multiplicity of locations in space; detecting a plurality of spatial frequency patterns resulting from illuminating the object in each case with an individual illumination element or a plurality of illumination elements from the multiplicity of illumination elements; centering each spatial frequency pattern at a position in the Fourier space corresponding to a nominal spatial frequency of the respective illumination element or of the respective illumination elements; and reconstructing the image using a totality of all the respectively centered spatial frequency patterns.

### CROSS-REFERENCE TO RELATED APPLICATIONS

This application is a U.S. National Stage Application of International Application No. PCT/EP2023/062346 filed May 10, 2023, which designates the United States of America, and claims priority to EP Application Serial No. 22172989.0 filed May 12, 2022, the contents of which are hereby incorporated by reference in their entirety.

### TECHNICAL FIELD

The present disclosure relates to images. Various embodiments of the teachings herein include systems and/or methods for the Fourier ptychographic generation of an image of an object by means of a color-corrected optical unit by illuminating the object with a multiplicity of illumination elements arranged in distributed fashion at a corresponding multiplicity of locations in space.

### BACKGROUND

Ptychography is a microscopic method. The sample to be examined is scanned by an electromagnetic beam or a particle beam, which is scattered by the material and forms a diffraction and/or interference pattern. The beam changes its position a little each time (e.g. different locations of the light sources), such that it impinges on the sample at different angles and correspondingly also generates different diffraction and/or interference patterns. From the diffraction and/or interference patterns from many locations of the sample, an image of the entire sample can be computed by an algorithm (e.g. inverse Fourier transformation). The diffraction and/or interference pattern also contains information about phases of the waves and can thus also image transparent structures, for example.

In Fourier ptychography (FP), the image reconstruction requires a wavelength parameter to carry out a correct reconstruction. From a technical standpoint, the spatial frequency spectrum of the diffraction pattern has to be linked with the lateral spatial frequency pattern of the image such as is detected by the detector and generated by a subsequent Fourier transformation of the image. During the imaging, in general, rather than a single wavelength a narrower or wider emission spectrum of a light source is used. In the current implementations of Fourier ptychography, the spectral profile is not taken into account, and the wavelength parameter is conversely determined as an (effective or averaged) value in the emission spectrum of the light source by virtue of the reconstructed image being optimized e.g. by variation of the value for the wavelength parameter.

In the literature and in evaluation codes such as are available in software packages for Fourier ptychography (e.g. G. Zheng: “Fourier ptychographic imaging”, 2016, published by: Morgan & Claypool Publishers, ISBN 978-1-64327-860-5), at the present time there is only the one parameter of wavelength which can be optimized in each reconstruction to optimize the image quality. There is no approach, however, that takes account of the spectral profile of the light source. Everything is covered indirectly by the one parameter of wavelength, which approximately corresponds to the weighted average of the effective wavelength which is transmitted by the entire optical system.

### SUMMARY

Consequently, the present disclosure provides teachings useful in simplifying the Fourier ptychographic reconstruction of an image of an object. For example, some embodiments of the teachings herein include a method for the Fourier ptychographic generation of an image of an object by means of a color-corrected optical unit (6) by illuminating the object with a multiplicity of illumination elements (4) arranged in distributed fashion at a corresponding multiplicity of locations in space, characterized by detecting a plurality of spatial frequency patterns (16) resulting from illuminating the object in each case with an individual illumination element or a plurality of illumination elements from the multiplicity of illumination elements (4), centering each spatial frequency pattern (16) at a position in the Fourier space (4) which corresponds to a nominal spatial frequency (8) of the respective illumination element (4) or of the respective illumination elements, and reconstructing the image using a totality y of all the respectively centered spatial frequency patterns (16).

In some embodiments, the multiplicity of locations in space at which the illumination elements (4) are arranged in distributed fashion lie on an area which is configured as planar, ellipsoidal or in the shape of a spherical shell section.

In some embodiments, the respective nominal spatial frequency (8) is ascertained from an angle of incidence of the respective illumination element (4) on the object or a position of the respective illumination element (4).

In some embodiments, the respective nominal spatial frequency (8) is calculated in the case of a rectangular arrangement of the multiplicity of illumination elements (4) which have a uniform spacing Pₓ and P_{y} in orthogonal spatial directions x and y with respect to one another, using the formulae:

$${K}_{x , i} = atan ( i * {P}_{x} / D ) and$$

$${K}_{y , i} = atan ( j * {P}_{y} / D ) ,$$

wherein

D corresponds to a distance between an object plane (2), in which the object is situated, and an illumination plane, in which the multiplicity of illumination elements (4) are arranged, or in the case of a spherical or ellipsoidal arrangement of the multiplicity of illumination elements which are arranged at azimuthal angles φᵢⱼ in rings i and polar angles ϑᵢ with respect to an optical axis of the optical unit (6), using the formulae:

$${K}_{x , ij} = {ϑ}_{i} cos ( {φ}_{ij} + {δφ}_{i} ) and$$

$${K}_{y , ij} = {ϑ}_{i} sin ( {φ}_{ij} + {δφ}_{i} ) ,$$

wherein

δφ₁ is a uniform azimuthal spacing of the illumination elements (4) on the respective ring i.

In some embodiments, reconstructing the image includes an inverse Fourier transformation of the totality of all the respectively centered spatial frequency patterns (16).

In some embodiments, a spatial frequency domain (7) used for reconstructing the image is limited for this image on the basis of a maximum spatial frequency defined by a numerical aperture of the color-corrected optical unit (6).

In some embodiments, each spatial frequency pattern (16) is limited by way of a graduated or apodization filter configured in accordance with a wavelength profile of the illumination elements (4).

In some embodiments, each spatial frequency pattern (16) is corrected by way of an inverse modulation transfer function of the color-corrected optical unit (6).

In some embodiments, during the reconstructing each individual image obtained by way of the individual illumination element or the plurality of illumination elements from the multiplicity of illumination elements (4) is freed of the modulation transfer function of the color-corrected optical unit (6) by deconvolution, each individual image corrected in this way is subsequently transformed to a respective corrected spatial frequency pattern and only the corrected spatial frequency patterns are merged.

In some embodiments, during the reconstructing each individual image obtained by way of the individual illumination element or the plurality of illumination elements from the multiplicity of illumination elements (4) is transformed to a respective spatial frequency pattern (16) by Fourier transformation, each spatial frequency pattern is subsequently freed of influences of the optical unit (6) and/or of the illumination elements (4) on a respective transfer function for Fourier components of the respective spatial frequency pattern and only the spatial frequency patterns corrected in this way are merged.

In some embodiments, during the reconstructing of the image all spatial frequency patterns are merged with the aid of an iterative optimization algorithm.

As another example, some embodiments include an apparatus for the Fourier ptychographic generation of an image of an object comprising: a color-corrected optical unit (6) and an illumination device (3) for illuminating the object with a multiplicity of illumination elements (4) arranged in distributed fashion at a corresponding multiplicity of locations in space, a detection device (10) for detecting a plurality of spatial frequency patterns resulting from illuminating the object in each case with an individual illumination element or a plurality of illumination elements from the multiplicity of illumination elements (4), and a computing device for centering each spatial frequency pattern (16) at a position in the Fourier space which corresponds to a nominal spatial frequency (8) of the respective illumination element or of the respective illumination elements (4), and for reconstructing the image using a totality of all the respectively centered spatial frequency patterns (16).

As another example, some embodiments include a computer program, comprising instructions which, during execution of the program by an apparatus as described herein, cause said apparatus to carry out one or more of the methods described herein.

As another example, some embodiments include a computer-readable storage medium, comprising instructions which, during execution by an apparatus as described herein, cause said apparatus to carry out one or more of the methods described herein.

### BRIEF DESCRIPTION OF THE DRAWINGS

Exemplary embodiments of the teachings herein are described below. In this respect:

FIG. 1 shows a setup of an FP microscope;

FIG. 2 shows an enlarged view of the illumination device of the FP microscope;

FIG. 3 shows an enlarged illustration of the object plane of the FP microscope;

FIG. 4 shows a schematic view of a rectangular illumination arrangement;

FIG. 5 shows a schematic plan view of a spherical illumination arrangement;

FIG. 6 shows the Fourier space of the arrangement from FIG. 4;

FIG. 7 shows the Fourier space of the arrangement from FIG. 5;

FIG. 8 shows a spectrum of an illumination element;

FIG. 9 shows resolution limits in the Fourier space;

FIG. 10 shows an amplitude distribution in the Fourier space;

FIG. 11 shows a schematic illustration of a reconstruction sequence;

FIG. 12 shows a transfer function of an optical system;

FIG. 13 shows a normalized transfer function;

FIG. 14 shows a spectral distribution taking account of the optical system;

FIG. 15 shows a modulation transfer function of a real optical system;

FIG. 16 shows a flow diagram of a reconstruction algorithm;

FIG. 17 shows a flow diagram of an alternative reconstruction algorithm;

FIG. 18 shows the Fourier space of the rectangular illumination arrangement with K-spaces of the image sensor; and

FIG. 19 shows the Fourier space spherical illumination arrangement with K-spaces of the image sensor.

### DETAILED DESCRIPTION

As an example, teachings of the present disclosure include a method for the Fourier ptychographic generation of an image of an object by means of a color-corrected optical unit. The image of an imaging system is typically color-corrected to a very high extent. This is a prerequisite for all imaging systems from the microscope through to macroscopic imaging systems, photographic cameras, and the like. Even in critical applications such as lithography, the respective optical unit is color-corrected for the optical spectrum used. In chromatic confocal imaging systems as well (e.g. confocal white light sensors or color scanning microscopes such as the Zeiss CSM with Nipkow disk), the lateral chromatic aberration is compensated for and only an axial chromatic aberration with specific properties is incorporated into the system.

The methods described herein include illuminating the object with a multiplicity of illumination elements arranged in distributed fashion at a corresponding multiplicity of locations in space. The illumination source for the object is an illumination device comprising many individual illumination elements which can be situated at predetermined locations in space. In some embodiments, a matrix emitter is involved. Each individual illumination element may be regarded as pointlike and can accordingly be located at the respective point.

In some embodiments, the method includes detecting a plurality of spatial frequency patterns resulting from illuminating the object in each case with an individual illumination element or a plurality sf of illumination elements from the multiplicity of illumination elements. The object is thus illuminated for example separately with individual illumination elements of the illumination device. However, the illuminating can also be effected with groups of illumination elements from said multiplicity of illumination elements. The object is thus related successively with individual illumination elements or a plurality of illumination elements from the multiplicity of illumination elements. At the same time in this case either an individual illumination element or a group of illumination elements is switched on for the purpose of illumination.

Subsequently, centering each spatial frequency pattern at a (respective) position in the Fourier space which corresponds to a nominal spatial frequency of the respective illumination element or of the respective illumination elements is carried out. The nominal spatial frequency is that point in the Fourier space which represents the center of the spatial frequency pattern of an illumination element as a function of the location thereof. Each spatial frequency pattern or interference pattern is thus centered at a specific place in the Fourier space which corresponds to the nominal spatial frequency thereof.

Finally, reconstructing the image using a totality of all the respectively centered spatial frequency patterns takes place. By way of example, all the spatial frequency patterns are “summed” (i.e. spatially merged) and an image is obtained therefrom by inverse Fourier transformation. On account of the color-corrected optical unit there is no dispersion, and so the reconstructing can take place independently of wavelength.

In some embodiments, the multiplicity of locations in space at which the illumination elements are arranged in distributed fashion lie on an area which is configured as planar, ellipsoidal or in the shape of a spherical shell section. In this regard, the illumination elements can be distributed uniformly on a rectangular area, for example. This results in a matrix emitter, for example. In some embodiments, the illumination elements can also be arranged in distributed fashion on the surface of a sphere (or of some other body). In some embodiments, they can be distributed uniformly on a spherical shell section. Specifically, this distribution can also be afforded on a hemisphere. Both a distribution on an e.g. rectangular planar area and a distribution on a spherical section enable a simple reconstruction algorithm for reconstructing an image.

In some embodiments, the respective nominal spatial frequency is ascertained (directly) from an angle of incidence of the respective illumination element on the object or a position of the respective illumination element. By way of example, in the case of a rectangular arrangement of the illumination elements, it may be advantageous to directly determine the nominal spatial frequency of the respective illumination element from the position thereof (e.g. x- and y-coordinates). In the case of a spherical (i.e. in the shape of a spherical shell (section)) arrangement of the illumination elements, by contrast, it may be advantageous if the nominal spatial frequency of a respective illumination element is ascertained directly from the angle of incidence thereof on the object. In this regard, the coordinates in the K-space (Fourier space) can be ascertained directly from the polar angle and the azimuthal angle of each illumination element.

As has already been indicated above, in the case of a rectangular arrangement of the multiplicity of illumination elements which have a uniform spacing Pₓ and P_{y} in orthogonal spatial directions x and y with respect to one another, the nominal spatial frequencies can thus be calculated using the formulae: K_{x,i}=atan(i*Pₓ/D) and K_{y,j}=atan(j*P_{y}/D), wherein D corresponds to a distance between an object plane, in which the object is situated, and an illumination plane, in which the multiplicity of illumination elements are arranged. In some embodiments, in the case of a spherical arrangement of the multiplicity of illumination elements which are arranged at azimuthal angles φᵢⱼ in rings i and polar angles ϑᵢ with respect to an optical axis of the optical unit, the nominal spatial frequencies can be calculated using the formulae: K_{x,ij}=ϑᵢ cos (φᵢⱼ+δφᵢ) and K_{y,ij}=ϑᵢ sin (φᵢⱼ+δφᵢ), wherein δφᵢ is a uniform azimuthal spacing of the illumination elements on the respective ring i.

In the spherical case or in the case of the sphere, therefore, the nominal spatial frequencies can be calculated from the spherical coordinates describing the locations of the light sources, and in the case of a planar array of illumination elements, they can be calculated from the Cartesian coordinates of the respective light Source locations. The simple equations arise for the case where the sphere or the array is also “centered” on the optical axis of the imaging system and the locations of the light sources are known for this alignment of the illumination system. If there is no centering, “offsets” would have to be taken into account in order to bring about the centering computationally.

As mentioned, reconstructing the image can include an inverse Fourier transformation of the totality of all the respectively centered spatial frequency patterns. This means that all spatial frequency patterns obtained by way of the individual illumination elements or groups of illumination elements are taken into account in the inverse transformation. The inverse transformation can thus be realized by a simple algorithm.

In some embodiments, a spatial frequency domain or Fourier space used for reconstructing the image is limited on the basis of a maximum spatial frequency defined by a numerical aperture of the color-corrected optical unit. The spatial frequency for the resolution limit thus results directly from the numerical aperture. In this case, however, there is a wavelength dependence to the effect that for the calculation of the spatial frequency the numerical aperture is divided by the wavelength.

Furthermore, each spatial frequency pattern can be limited by way of a graduated or apodization filter configured in accordance with the optical and/or wavelength-dependent transfer properties, e.g. on the basis of the modulation transfer function, of the optical system. A reduction of the computational complexity in the reconstruction can be achieved by this limitation of the spatial frequency spectrum for each of the individual images.

In some embodiments, each spatial frequency pattern is corrected by way of an inverse modulation transfer function of the color-corrected optical unit. This correction has the effect that the influence of the color-corrected optical unit on the image content is reduced and at best completely compensated for. Virtually undistorted spatial frequency patterns can be ascertained in this way.

In some embodiments, during the reconstructing each individual image obtained by way of the individual illumination element of the plurality of illumination elements from the multiplicity of illumination elements is freed of the modulation transfer function of the color-corrected optical unit by deconvolution, each individual image corrected in this way is subsequently transformed to a respective corrected spatial frequency pattern and only the corrected spatial frequency patterns are merged. In the present case, therefore, a correction of the individual images already takes place in the space domain before the transformation into the spatial frequency domain.

In some embodiments, during the reconstructing each individual image obtained by way of the individual illumination element or the plurality of illumination elements from the multiplicity of illumination elements can be transformed to a respective spatial frequency pattern Fourier by transformation, each spatial frequency pattern is then subsequently freed of the influences of the optical unit and/or of the illumination elements on respective transfer function for Fourier components of the respective spatial frequency pattern, and only the spatial frequency patterns corrected in this way are merged. Here, therefore, the correction takes place in the spatial frequency domain and not in the space domain. This, too, can afford advantages with regard to the computational speed.

In some embodiments, during the reconstructing of the image all spatial frequency patterns are merged with the aid of an iterative optimization algorithm. In this way, it is possible to combine the spatial frequency patterns in such a way that ultimately a high-resolution image can be obtained.

Some embodiments include an apparatus for the Fourier ptychographic generation of an image of an object comprising: a color-corrected optical unit; an illumination device for illuminating the object with a multiplicity of illumination elements arranged in distributed fashion at a corresponding multiplicity of locations in space; a detection device for detecting a plurality of spatial frequency patterns resulting from illuminating the object in each case with an individual illumination element or a plurality of illumination elements from the multiplicity of illumination elements, and a computing device (configured) for centering each spatial frequency pattern at a position in the Fourier space which corresponds to a nominal spatial frequency of the respective illumination element or of the respective illumination elements, and for reconstructing the image using a totality of all the respectively centered spatial frequency patterns. The computing device can be integrated into the optical sensor or form a separate unit.

The advantages and developments set out above in connection with the methods described herein analogously also apply to the apparatus. Accordingly, the method features presented should be regarded as functional features of corresponding means in the case of the apparatus.

Some embodiments include a computer program, comprising instructions which, during execution of the program by an apparatus mentioned above, cause said apparatus to carry out one or more of the methods outlined above. Furthermore, a computer-readable storage medium can be provided, comprising instructions which, during execution by the above apparatus, cause said apparatus to carry out one or more of the methods mentioned. The storage medium can be configured e.g. at least in part as a nonvolatile data memory (e.g. as a flash memory and/or as an SSD—solid state drive) and/or at least in part as a volatile data memory (e.g. as a RAM—random access memory). The storage medium can furthermore be realized in a data memory of a processor circuit. However, the storage medium can also be operated for example as a so-called app store server on the Internet. A processor circuit comprising at least one microprocessor can be provided by a computer or computer network. The instructions can be provided as binary code or assembler and/or as source code of a programming language (e.g. C).

For applications or application situations which may arise in the method and which are not explicitly described here, it can be provided that in accordance with the methods an error message and/or a request for the inputting of user feedback are/is output and/or a standard setting and/or a predetermined initial state are/is set.

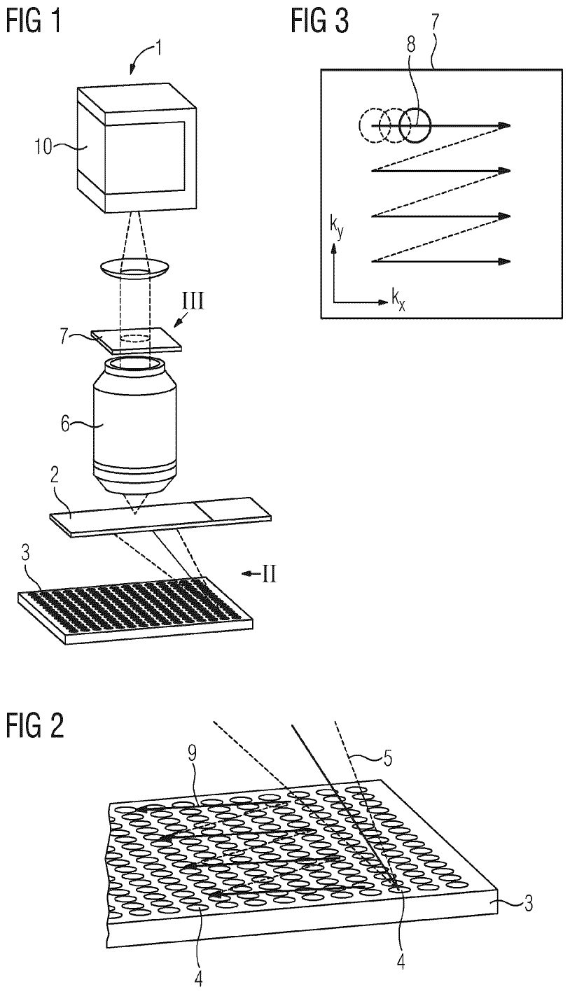

FIG. 1 shows a customary setup of a Fourier ptychography microscope 1. The latter has an object plane, in which an object 2 to be imaged is arranged. The object 2 is illuminated from below with the aid of an illumination device 3.

FIG. 2 shows an enlarged detail of the illumination device 3. The latter has a multiplicity of regularly arranged illumination elements 4. In the present example, the illumination elements are arranged in matrix form in orthogonal directions x and y. Each illumination element can be realized as an LED, for example, which emits an illumination beam 5 at the object 2. In FIG. 2, the arrows 6 indicate the direction in which the individual illumination elements 4 can be successively switched on and off again. In this regard, for example, a switch-on order can consist in successively switching on firstly the illumination elements 4 in a first row, subsequently those in a second row and so on. In principle, an arbitrary order can be chosen. Furthermore, it is also possible for a plurality of illumination elements 4 in a group to be jointly switched on and switched off again.

The illumination beam of each illumination element 4 is diffracted by the object 2 and collected by an optical unit 6. The Fourier space 7 for the imaging of the object 2 arises on the other side of the optical unit 6.

This Fourier space 7 is illustrated in an enlarged manner in plan view in FIG. 3. It has the coordinates Kₓ and K_{y}. For each individual illumination element 4, a nominal spatial frequency 8 arises in the Fourier space 7. This nominal spatial frequency 8 represents for example the center point of the illustrated circle and moves analogously to the arrow 9 from FIG. 2.

The Fourier space 7 is captured or sampled by an optical sensor 10 of the FP microscope 1.

This FP microscope (here transmitted-light microscope) makes it possible to capture an image sequence of an object with different collimated or very low-aperture spatial illuminations in the bright field and/or dark field mode. Instead of the flat arrangement of the illumination elements 4, a (hemi-)spherical arrangement is also possible. It can be assumed that the microscope is optically corrected in such a way that it captures images of the sample with good quality, without appreciable distortions or chromatic aberrations. Optionally, the illumination wavelength can be chosen by way of the LED used or in combination with bandpass filters having a full width at half maximum of e.g. 10, 50 or 80 nm in front of the black-and-white camera. The tube lens of the FP microscope may cause imaging aberrations. These effects may occur in particular in the paraxial regions of the object space of e.g. <+/−500 μm with respect to the optical axis.

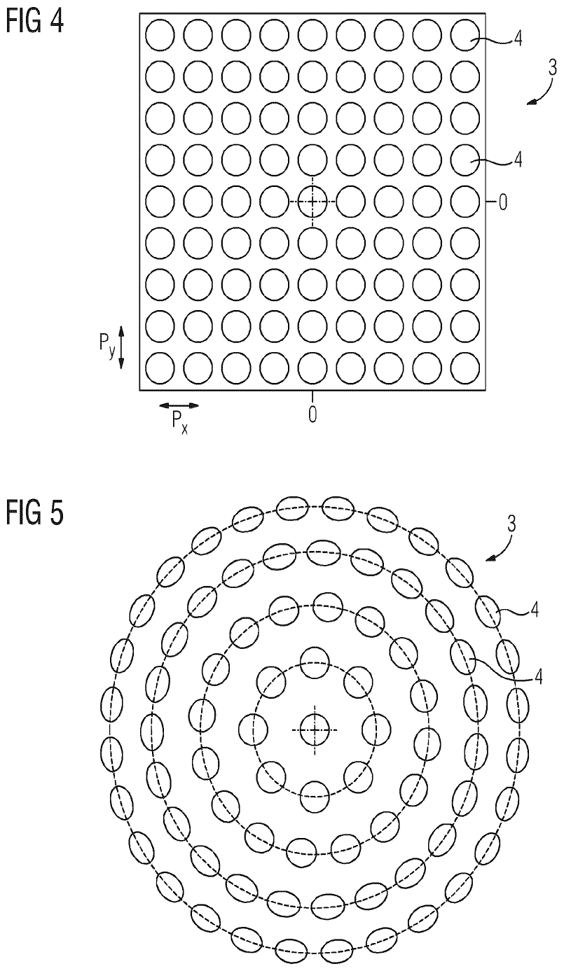

Rectangular arrangements and spherical arrangements of illumination elements in the space domain and the effects thereof in the spatial frequency domain will now be explained in greater detail with reference to FIGS. 4 to 7.

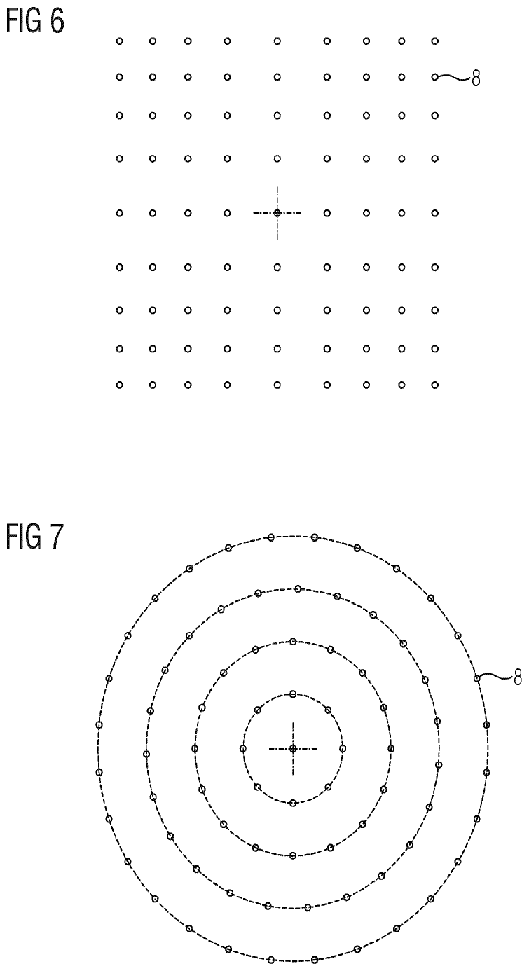

FIG. 4 shows a rectangular arrangement of illumination elements 4. The illumination device here has 81 illumination elements 4 (e.g. LEDs). They have a spacing Pₓ in the horizontal direction x and a spacing P_{y} in the vertical direction y. Each illumination element has corresponding coordinates (i, j). The position of each illumination element 4 in an illumination angle coordinate system can be specified as:

$${K}_{x , i} = a tan ( i * {P}_{x} / D ) and$$

$${K}_{y , j} = a tan ( j * {P}_{y} / D ) ,$$

where i is for example an integer from the range of −m to m and j is an integer from the range of −n to n. D corresponds to the distance between the object plane of the object 2 and the illumination plane of the illumination device 3. FIG. 6 shows a corresponding illumination coordinate system in the Fourier space for the rectangular illumination arrangement from FIG. 4. Each point represents a nominal spatial frequency 8 for this rectangular arrangement. The sampling is accordingly not equidistant and the axes of symmetry may exhibit aliasing effects. The point size for the illumination elements is determined by the numerical aperture of the illumination of each LED from the viewpoint of the object. In the case of flat arrangements, the point size decreases with increasing distance from the optical axis.

FIG. 5 illustrates a spherical arrangement of illumination elements 4 in a plan view. The illumination elements or LEDs are at a constant radial distance R from the intersection point of the optical axis (+) and the object plane. The rings have a fixed angle increment Δϑ. The LEDs in the rings have a constant angular spacing within the respective ring. The individual azimuthal displacement δφᵢ per ring serves for avoiding crosstalk effects.

The arrangement in FIG. 5 here has, purely by way of example, 76 illumination elements 4 in four rings around the center. φᵢⱼ represents the azimuthal angle in the ring i. ϑᵢ corresponds to the polar angle with respect to the optical axis.

The center position of the illumination elements in the illumination angle coordinate system can be represented as follows:

$$\begin{matrix}{K}_{x , ij} = {ϑ}_{i} cos ( {φ}_{ij} + {δφ}_{i} ) and \\ {K}_{y , ij} = {ϑ}_{i} sin ( {φ}_{ij} + {δφ}_{i} )\end{matrix}$$

or explicitly

$$\begin{matrix}{K}_{x , ij} = i * Δϑ cos ( j * {Δφ}_{i} + {δφ}_{i} ) and \\ {K}_{y , ij} = {ϑ}_{i} sin ( j * {Δφ}_{i} + {δφ}_{i} )\end{matrix}$$

where i is an integer between 0 and N_{R}−1 and j is an integer between 1 and N_{R1} or 1 and N_{R2}, or 1 and N_{R}, depending on ring number. In this case, N_{R} amounts to the maximum number of illumination elements on the respective ring. The spacing in angle coordinates between the individual illumination elements is uniform owing to the spherical setup with constant angle increments. FIG. 7 shows the illumination coordinate system in the Fourier space corresponding to the spherical arrangement of the illumination elements 4 from FIG. 5. Equidistant sampling in a radial direction and in a circumferential direction is possible here. Owing to the azimuthal displacement Δφᵢ in each ring there is no axis of symmetry.

The combination of the illumination coordinate system and the sampling coordinate system of the optical sensor in the Fourier space is explained below. The illumination coordinate system extends over a larger range in the Fourier space coordinate system than the image coordinate system (also called sampling coordinate system). In order to combine both coordinate systems, their measures or physical units must match. The measure in the illumination coordinate system is the unitless numerical aperture, i.e. the sine of an angle. The measure in the sampling coordinate system is for example 1/mm or 1/μm, i.e. the inverse length.

The link between both coordinate systems is the wavelength λ used, since the diffraction formula couples the structure width λ, the diffraction angle αₙ and the respective wavelength λ to one another by way of

$$sin {α}_{n} = n * λ / Λ$$

where n indicates the order of diffraction (normally n=1).

This implies some general aspects. Firstly, the diffraction pattern is highly dispersive (sin α˜λ) for a given structure width λ. Secondly, the wavelength and the bandwidth of the illumination are of great importance for the reconstruction in standard methods. In particular, the effective wavelength plays a major part in the conversion of the illumination coordinate space into the Fourier coordinate space of the sampling. In regard to the bandwidth, the dispersion is of great importance in two respects. The higher the numerical aperture of the optical unit, the greater the effects may be. This is unproblematic only if the optical unit is well corrected. In regard to the diffraction, the bandwidth of the illuminating light correlates directly with the “fuzziness” in the diffraction angles for the aperture plane. The effective wavelength arises as convolution from the LED emission plus filter and sensor sensitivity and modulation transfer function at the respective wavelength.

For the current reconstruction algorithms, this gives rise to consequences and advantages below:
for a given wavelength/effective wavelength and a given numerical aperture there is a deterministic connection transformation for illumination and sampling coordinate systems if the illumination system is calibrated in angles relative to the sensor coordinate axis.
The bandwidth of the imaging system need only be controlled or limited in order to avoid an image deterioration on account of chromatic aberration during imaging if a high numerical aperture and high-resolution, highly detailed images are striven for. As long as the camera optical unit and the image are of high quality, the wavelength bandwidth is unproblematic.
Different imaging wavelengths may be used to generate Fourier patterns even when there is little sampling overlap for each of the wavelengths.

By comparison with conventional reconstruction algorithms, the teachings herein include the observation that the optical unit and thus the images captured by the image sensor in a plane conjugate to the object plane are of high quality. With a fully color-corrected optical unit, there is thus no dispersion and hence no wavelength effect in the image. Therefore, the invention provides a dispersion-free—not wavelength-dependent—approach for the reconstruction of ptychography images. For this purpose, the numerical aperture of the illumination must be linked with the spatial image frequency, without the concept of the diffraction angles having to be introduced.

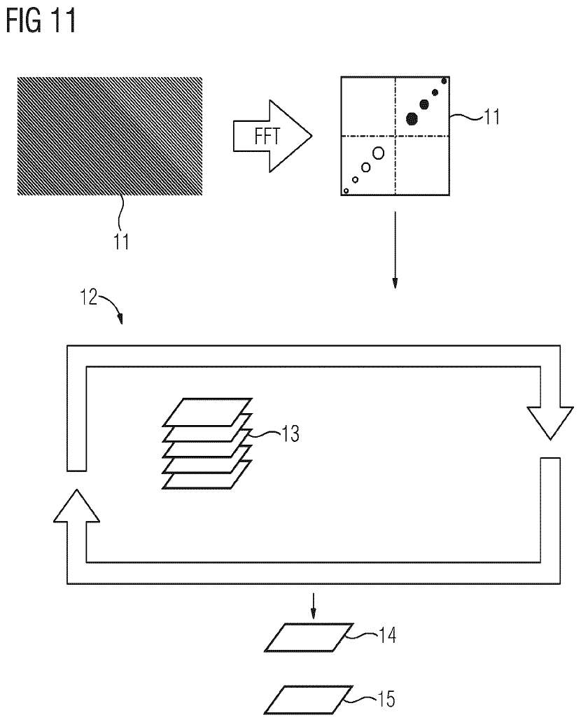

In order to clarify this difference, firstly with reference to FIG. 11 a brief explanation will be given of how an FP reconstruction sequence in accordance with the prior art takes place by way of wavelength-based angle transformation. The starting point is for example an object pattern 11 in the space domain. After a Fourier transformation (FFT), a corresponding overtone spectrum 11′ with line spacings and complex conjugate components arises in the spatial frequency domain or Fourier space. For the reconstruction, it should be taken into consideration that a blue wavelength (λ₁) is shorter than a green wavelength (λ₂) and the latter is in turn shorter than a red wavelength (λ₃). The angle of incidence for each illumination setting is wavelength-independent and is αᵢ and βⱼ, where αᵢ is the polar angle and βⱼ is the azimuthal angle. Each light source or each illumination element can thus be assigned angle coordinates (αᵢ, βⱼ). By way of the wavelength as parameter, the respective angle can be converted into a grating constant, e.g. simplified for light incidence perpendicular to the grating plane:

$${G}_{1} = {λ}_{1} / sin ( {α}_{1} ) , {G}_{2} = {λ}_{2} / sin ( {α}_{2} ) und {G}_{3} = {λ}_{3} / sin ( {α}_{3} ) .$$

Each Fourier transformation pattern then lies in the Fourier space with its center point at the place (gᵢ, βⱼ), where gᵢ=1/Gᵢ is the respective grating frequency in a common coordinate system for the Fourier transformation and the grating spatial frequency. A maximum filter for gᵢ can be realized as g_{i,max}=2π*NA/λᵢ.

Filtering of the Fourier space with respect to the maximum diffraction angle defined by the numerical aperture of the optical unit and the wavelength thus gives rise to the effect that the intensity in the Fourier space is a function of the polar angle αᵢ, the azimuthal angle βⱼ, the wavelength λᵢ and the numerical aperture, specifically:

I₁(gᵢ,βⱼ)=f(αᵢ,βⱼ,λ₁,NA),

I₂(gᵢ,βⱼ)=f(αᵢ,βⱼ,λ₂,NA) and

I₃(gᵢ,βⱼ)=f(αᵢ,βⱼ,λ₃,NA).

By means of an iterative algorithm 12, a set of images as input with boundary condition gives rise to a high-resolution image with aggregate amplitude and phase of partial images (self-consistency in overlap regions of the Fourier space). This results in a corresponding monochromatic output image 14 of the corresponding color and also one phase image 15 per color.

Another possibility for coupling the opening angle of the illumination and the spatial frequencies of the image plane consists in using the concept of the resolution limit of a minimum structure dₘᵢₙ by way of an optical system with numerical aperture NA and wavelength λ:

$${d}_{min} = {k}_{1} * λ / NA$$

In this case, k₁ is a parameter that is dependent on the resolution criterion employed. For example, the Rayleigh criterion k₁=0.61 or the Sparrow criterion k₁=0.5=k_{1,min} is used. For a modern camera sensor with linear intensity scaling, k₁=0.5 holds true.

The resolution limit dₘᵢₙ (λ, k₁, NA) for a given imaging setup with fixed k₁ and NA can be transferred like the camera pixels directly into a spatial frequency:

$$k ( λ ) = 1 / ( 2 * {d}_{min} ( λ ) ) = NA / ( 2 * {k}_{1} * λ )$$

In some embodiments, for a given camera sensor and k₁ there is a limit wavelength λ that can transfer the entire information content of the image:

$${d}_{min} = 2 * {d}_{pixel} = {k}_{1} * λ / NA$$

This results in:

$${λ}_{min} = 2 * NA * {d}_{pixel} / {k}_{1}$$

where all parameters on the right-hand side of the last equation are fixed and are determined by the parameters of the imaging setup. λₘᵢₙ is the shortest wavelength for the imaging setup that utilizes the full numerical aperture NA of the objective in order to image structures with the detector of a specific pixel spacing dₚᵢₓₑₗ, so that the resolution can thus be limited.

The corresponding spatial frequency is calculated as follows:

$${k}_{NA} = 2 * π / {λ}_{min} = 2 * π / ( 2 * NA * {d}_{pixel} / {k}_{1} ) = π * {k}_{1} / ( NA * {d}_{pixel} )$$

In a two-dimensional plane the spatial frequency can be rotated according to the azimuthal angle βⱼ of the illumination and can be split into the Cartesian components where:

$${k}_{x , i , j} = {k}_{NA , ij} cos ( {β}_{j} ) {k}_{y , i , j} = {k}_{NA , ij} sin ( {β}_{j} )$$

For each light source (ij) the Fourier transform of the respective image is set to the position (K_{x,i,j}, K_{y,i,j}) in the resulting Fourier space for the image reconstruction.

For a given optical system with a maximum numerical aperture and different wavelengths in the illumination spectrum, the spatial frequency limit to be calculated for all wavelengths and fixed k₁ is wavelength-dependent, specifically according to the formula:

$$k ( λ ) = 2 * π * NA / ( 2 * {k}_{1} * λ ) = π * NA / ( {k}_{1} * λ )$$

The factor 2*π in the above formulae may be dependent on the manner in which the normalization is carried out in the Fourier transformation. (Optionally, the normalization/calibration of a Fourier transformation is also carried out in a different way.) This entails the chance of including wavelength and bandwidth in the image reconstruction process in a native manner.

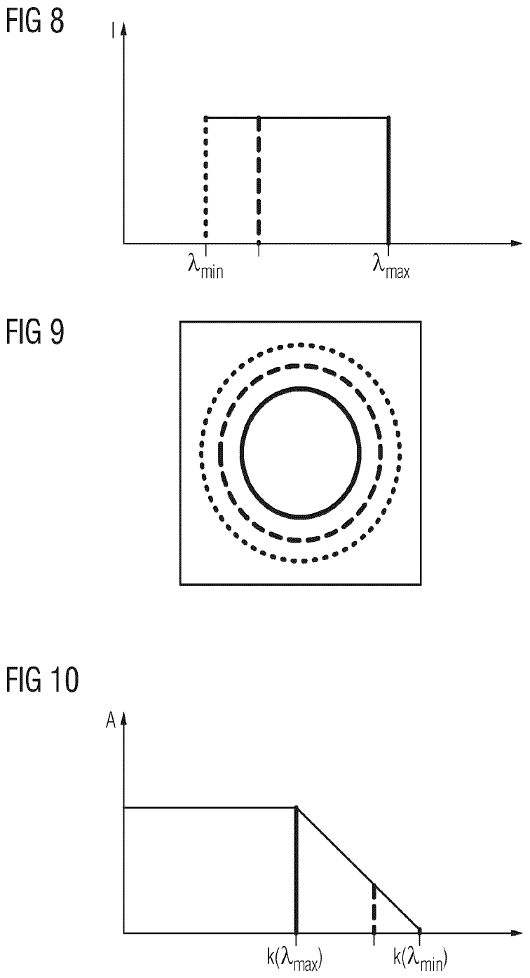

The longest wavelength used has the lowest resolution limit which can be attained with a spatial frequency related thereto. The shortest wavelength has the greatest spatial frequency content in the Fourier plane. Assuming that all wavelengths used in the range of λₘᵢₙ to λₘₐₓ have the same intensity (cf. FIG. 8), the constellation in accordance with FIG. 9 thus arises for the Fourier space. Accordingly, the resolution limits for short-wave light λₘᵢₙ in the Fourier space are significantly further outward than the resolution limits for long-wave light λₘₐₓ. Furthermore, FIG. 10 shows a radial section through the Fourier space. While the contribution of the spatial frequencies below k (λₘₐₓ) is constant (all frequencies make contributions), the contribution of the individual frequencies decreases outside k (λₘₐₓ). Above the spatial frequencies k (λₘₐₓ) the long-wave portions of the light can no longer make a contribution. Consequently, the portion of the contributions decreases continuously until finally a contribution can no longer be made even with the shortest wavelength λₘᵢₙ.

With this insight, a new approach arises for the reconstruction (cf. FIG. 11) and according to this approach the angle of incidence is determined or calibrated for each illumination source or each illumination element. This gives rise to a list of light source positions, for example:

LSₖ=(αᵢ,βⱼ) or (xᵢ,yⱼ)

In this case, αᵢ is the polar angle and βⱼ is the azimuthal angle.

The spatial frequency component for all (αᵢ, βⱼ) or (xᵢ, yⱼ) used can be calculated as follows:

$$\begin{matrix}{K}_{x , i , j} = cos ( {β}_{j} ) sin ( {α}_{i} ) ; \\ {K}_{y , i , j} = sin ( {β}_{j} ) sin ( {α}_{i} )\end{matrix}$$

or alternatively

$$\begin{matrix}{K}_{x , i , j} = {K}_{x , i} = a tan ( {x}_{i} / D ) ; \\ {K}_{y , i , j} = {K}_{y , j} = a tan ( {y}_{j} / D )\end{matrix}$$

Each Fourier transformation pattern then lies in the Fourier space with its center point at the place (K_{x,i,j}, K_{y,i,j}) of (K_{x,i}, K_{y,j}). The further reconstruction takes place in the iterative algorithm 12 in accordance with FIG. 11.

In an extended version of the reconstruction sequence, filtering of the Fourier space with respect to the maximum spatial frequency defined by the numerical aperture of the optical unit can be carried out. Spectral bandwidth information can be taken into account in the algorithm.

Furthermore, the new approach of the reconstruction sequence encompasses further potentials for improvements. Firstly, virtue of the new approach on the basis of the space vector or the illumination, spectral information on the basis of the color or wavelength band spectrum is possible and expedient, which is not possible in the prior art. Furthermore, it is possible to carry out filtering of the Fourier transformation for a raw image by way of an apodization filter according to the spectral profile/wavelength profile of the light source used for capturing the respective image.

The wavelength spectrum is generally an idealized top-hat or rectangular profile ranging from λₘᵢₙ to λₘₐₓ. For a square pixel size, the Fourier plane has a square shape. The step size of the sampling in the Fourier plane in the direction of the coordinate axis of the sensor is dependent on the number of pixels of the sensor in the respective axis. In the case of a square array, the sampling is of equal magnitude in both axes. The circles (cf. FIG. 9) show the region of the Fourier space of the image that is covered by the respective wavelength. The region of the Fourier plane that is not covered by the circles relates to spatial frequencies in the image which are not accessible for the contribution of a specific wavelength to the overall image. This involves sampling frequencies that go beyond the Nyquist theorem.

The sectional illustration of the Fourier plane in FIG. 10 already mentioned above is of particular interest. It shows how the wavelength spectrum appears for the correct reconstruction. The triangular shape between λₘᵢₙ and λₘₐₓ with a negative gradient is a direct consequence of the assumption that the light intensity is the same for each wavelength. In real cases, light sources generally do not have such uniform emission profiles, nor do the optical unit and the sample have such an ideal transmission performance.

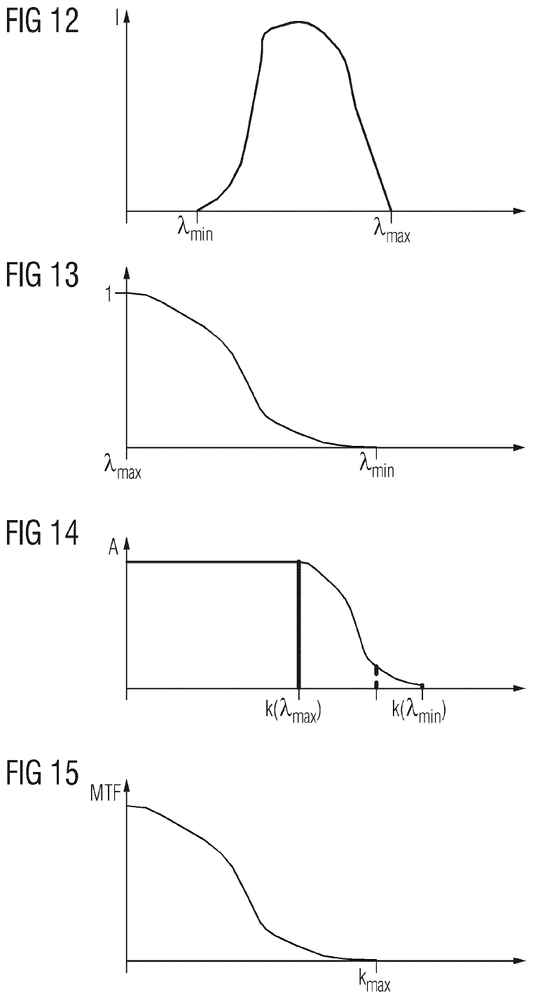

A realistic scenario involves an effective transfer profile of the optical system with a specific wavelength characteristic that is illustrated by way of example in FIG. 12. This curve of the spectral power distribution (which is regarded as a density function) leads to the weighted distribution function in accordance with FIG. 13 by way of taking the integral from a specific wavelength to λₘᵢₙ. It is normalized to 1 by the maximum value for the area beneath the curve between λₘᵢₙ and λₘₐₓ.

Taking this fact into account, the diagram for the radial section of the Fourier plane (cf. FIG. 10) changes according to FIG. 14, where the spectral distribution is contained in the transfer function for the Fourier components in order to filter the higher spatial frequency contributions. This transfer function can be interpreted as a wavelength-dependent pupil function corresponding to a pupil stop in the pupil of an optical imaging system. From a functional standpoint, this representation corresponds exactly to the optical function of a physical stop in the aperture plane in the case of spectrally corrected pupil imaging with a diameter matching the maximum aperture NAₘₐₓ of the objective.

Real optical systems do not have a constant transfer function over the entire frequency range of from 0 to the maximum transferred spatial frequency. In a real world, the frequency response is described by a modulation transfer frequency. It has the value 1 or its maximum value for the frequency 0 and falls to 0 for the maximum spatial frequency transferred by the system (cf. FIG. 15). During the reconstruction of Fourier ptychographic images, this effect has to be compensated for if the different spatial frequency patterns from the Fourier transformations of the various illumination directions are combined.

The modulation transfer function (MTF) can be determined by any known method, e.g. from the imaging of test structures and the evaluation of the contrast or by determining characteristic variables for the imaging performance (e.g. Seidel coefficients, Zernike coefficients) of the optical systems and calculating the MTF therefrom using a suitable formalism. The image or the Fourier spectrum of the image can then be corrected by the MTF in order to obtain an image of much higher quality, e.g. in the way that an ideal optical system would have imaged the object. The corrected Fourier spectra can then be merged into a common spectrum with greater spatial frequency content in order to generate a reconstructed image of high quality. For the merging process, it is possible to use known (iterative) optimization algorithms 12 for the image search, such as the Gerchberg-Saxton or Levenberg-Marquardt algorithms, or comparable methods for iteratively solving multidimensional and/or nonlinear problems.

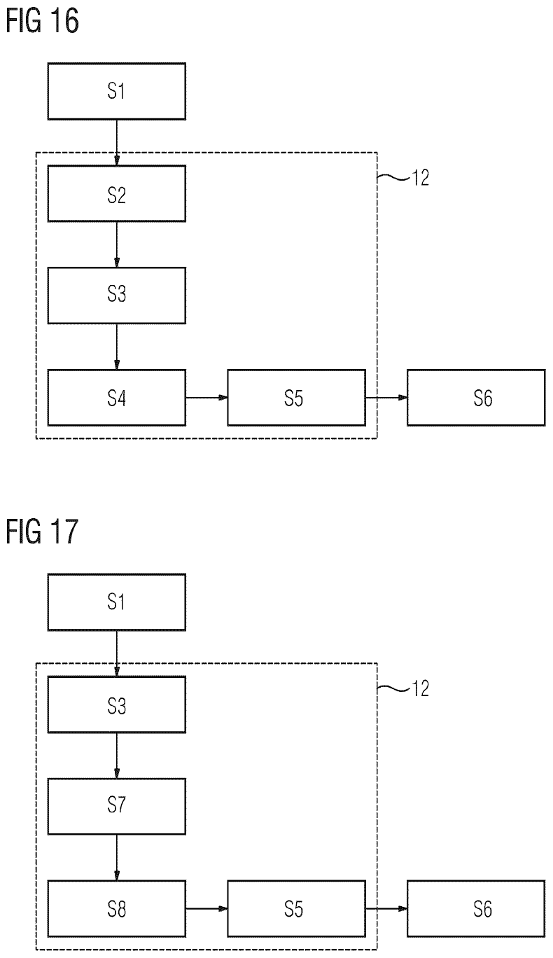

In general, the entire optimization could also be carried out in one step, as is the case in the prior art for Fourier ptychography reconstruction. In this sense, the functional flow diagrams in FIGS. 16 and 17 merely show a generic strategy for implementing the entire reconstruction process, which can be restructured without departing from the framework of the reconstruction aim.

In the example in FIG. 16, step S1 involves providing an image for an optimization algorithm 12 for image generation (e.g. the Gerchberg-Saxton or Levenberg-Marquardt algorithm), In the context of this algorithm 12, a deconvolution of image and MTF takes place in step S2. A Fourier transformation (FFT) into the Fourier space takes place in a subsequent step S3. The Fourier images are merged in the subsequent step S4. An inverse Fourier transformation for image generation takes place in the subsequent step S5. Steps S3 to S5 can be carried out iteratively, wherein an iteration cycle can also include a step for comparing the current image with at least one of the input images from S1 or an optimized input image following step S2. Ultimately, a high-quality output image can be provided in step S6.

In some embodiments, the reconstruction process can also be carried out according to the example in FIG. 17. In this case, too, firstly step S1 involves providing an image for the optimization algorithm 12. Within the latter, however, there is then directly a Fourier transformation in accordance with step S3. That is followed by step S7, which involves separating the contributions of the imaging system and of the object in the Fourier space. Merging of real/Fourier image is subsequently carried out in step S8 before there follows in turn an inverse Fourier transformation in accordance with step S5 in order to be able to provide a high-quality output image in accordance with step S6.

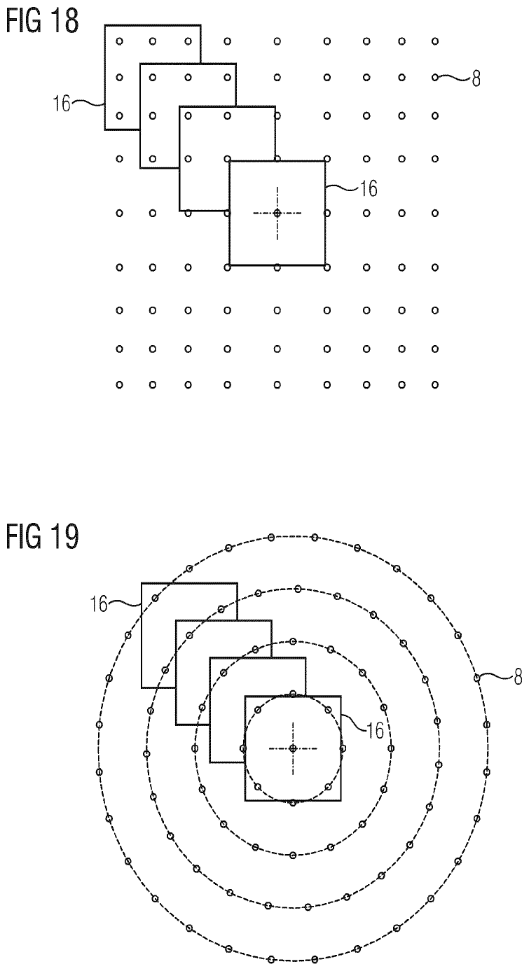

The concept of the combination of illumination and sampling coordinate systems in the Fourier space is vividly elucidated with reference to FIGS. 18 and 19, with correspondingly suitable scalings having been chosen for elucidation purposes. The basis for FIGS. 18 and 19 is the Fourier spaces from FIGS. 6 and 7 for a flat rectangular illumination device and a spherical illumination device, respectively. In the center of the two Fourier spaces there is in each case a spatial frequency pattern of the optical sensor for an illumination on the optical axis. Further spatial frequency patterns 16 (identical to the overtone spectrum 11′ from FIG. 11) of the optical sensor are plotted symbolically in the Fourier spaces, in each case centered at a nominal spatial frequency of the illumination device. The illumination coordinate system extends over a larger range in the Fourier space coordinate system than the imaging coordinate system. Besides the central image with coaxial illumination on the optical axis of the imaging coordinate system, it is thus possible to capture a plurality of images at other illumination angles. After the merging of the images in the Fourier space, the inverse transformation can take place, resulting in the high-resolution image.

What is claimed is:

1. A method for the Fourier ptychographic generation of an image of an object by means of a color-corrected optical unit, the method comprising:
illuminating the object with a multiplicity of illumination elements arranged in distributed fashion at a corresponding multiplicity of locations in space;
detecting a plurality of spatial frequency patterns resulting from illuminating the object in each case with an individual illumination element or a plurality of illumination elements from the multiplicity of illumination elements;
centering each spatial frequency pattern at a position in the Fourier space corresponding to a nominal spatial frequency of the respective illumination element or of the respective illumination elements; and
reconstructing the image using a totality of all the respectively centered spatial frequency patterns.

2. The method as claimed in claim 1, wherein the multiplicity of locations in space at which the illumination elements are arranged lie on an area configured as planar, ellipsoidal, or in the shape of a spherical shell section.

3. The method as claimed in claim 1, wherein the respective nominal spatial frequency is ascertained from an angle of incidence of the respective illumination element on the object or a position of the respective illumination element.

4. The method as claimed in claim 3, wherein the respective nominal spatial frequency is calculated,
in the case of a spherical or ellipsoidal arrangement of the multiplicity of illumination elements which are arranged at azimuthal angles φᵢⱼ in rings i and polar angles ϑᵢ with respect to an optical axis of the optical unit, using the formulae:
K_{z,ij}=ϑᵢ cos(φᵢⱼ×δφᵢ) and
K_{y,ij}=ϑᵢ sin(φᵢⱼ+δφᵢ), wherein
δφᵢ is a uniform azimuthal spacing of the illumination elements on the respective ring i.

5. The method as claimed in claim 1, wherein reconstructing the image includes using an inverse Fourier transformation of the totality of all the respectively centered spatial frequency patterns.

6. The method as claimed in claim 1, wherein a spatial frequency domain for reconstructing the image is limited for this image on the basis of a maximum spatial frequency defined by a numerical aperture of the color-corrected optical unit.

7. The method as claimed in claim 1, wherein each spatial frequency pattern is limited by way of a graduated or apodization filter configured in accordance with a wavelength profile of the illumination elements.

8. The method as claimed in claim 1, wherein each spatial frequency pattern is corrected by way of an inverse modulation pattern transfer function of the color-corrected optical unit.

9. The method as claimed in claim 8, wherein during the reconstructing each individual image obtained by way of the individual illumination element or the plurality of illumination elements from the multiplicity of illumination elements is freed of the modulation transfer function of the color-corrected optical unit by deconvolution, each individual image corrected in this way is subsequently transformed to a respective corrected spatial frequency pattern and only the corrected spatial frequency patterns are merged.

10. The method as claimed in claim 8, wherein during the reconstructing each individual image obtained by way of the individual illumination element or the plurality of illumination elements from the multiplicity of illumination elements is transformed to a respective spatial frequency pattern by Fourier transformation, each spatial frequency pattern is subsequently freed of influences of the optical unit and/or of the illumination elements on a respective transfer function for Fourier components of the respective spatial frequency pattern and only the spatial frequency patterns corrected in this way are merged.

11. The method as claimed in claim 1, wherein during the reconstructing of the image all spatial frequency patterns are merged with the aid of an iterative optimization algorithm.

12. An apparatus for the Fourier ptychographic generation of an image of an object, the apparatus comprising:
a color-corrected optical unit;
an illumination device to illuminate the object with a multiplicity of illumination elements arranged in distributed fashion at a corresponding multiplicity of locations in space;
a detection device to detect a plurality of spatial frequency patterns resulting from illuminating the object in each case with an individual illumination element or a plurality of illumination elements from the multiplicity of illumination elements; and
a computing device for centering each spatial frequency pattern at a position in the Fourier space which corresponds to a nominal spatial frequency of the respective illumination element or of the respective illumination elements, and to reconstruct the image using a totality of all the respectively centered spatial frequency patterns (16).

13. (canceled)

14. A tangible computer-readable storage medium storing instructions which, during execution, cause an apparatus to generate an image of an object with a color-corrected optical unit, the method by:
illuminating the object with a multiplicity of illumination elements arranged in distributed fashion at a corresponding multiplicity of locations in space;
detecting a plurality of spatial frequency patterns resulting from illuminating the object in each case with an individual illumination element or a plurality of illumination elements from the multiplicity of illumination elements;
centering each spatial frequency pattern at a position in the Fourier space corresponding to a nominal spatial frequency of the respective illumination element or of the respective illumination elements; and
reconstructing the image using a totality of all the respectively centered spatial frequency patterns.

15. The method as claimed in claim 3, wherein the respective nominal spatial frequency is calculated in the case of a rectangular arrangement of the multiplicity of illumination elements (4) which have a uniform spacing Pₓ and P_{y} in orthogonal spatial directions x and y with respect to one another, using the formulae:
$$\begin{matrix}{K}_{x , i} = a tan ( i * {P}_{x} / D ) and \\ {K}_{y , j} = a tan ( j * {P}_{y} / D ) ,\end{matrix}$$
wherein
D corresponds to a distance between an object plane, in which the object is situated, and an illumination plane, in which the multiplicity of illumination elements are arranged.
